(19) United States
(12) Patent Application Publication
(10) Pub. No.: US 2009/0248468 A1
(43) Pub. Date: Oct. 1, 2009

(54) Invention Review Board System and Method

(75) Inventors: John E. Cronin, Jericho, VT (US); Justin R. Kunz, Milford, NH (US)

Correspondence Address: DOWNS RACHLIN MARTIN PLLC, 199 MAIN STREET, P O BOX 190, BURLINGTON, VT, 05402-0190, US

(73) Assignee: IPCAPITAL GROUP, INC., Williston, VT (US)

(21) Appl. No.: 12/469,460

(22) Filed: May 20, 2009

Related U.S. Application Data
(62) Division of application No. 10/457,690, filed on Jun. 9, 2003.
(60) Provisional application No. 60/388,344, filed on Jun. 13, 2002.

(51) Int. Cl. G06F 17/20; G06Q 99/00; G06F 17/30; G06F 3/048; G06F 17/27

(52) U.S. Cl. 705/7; 715/780; 715/223; 704/9; 707/E17.044; 715/708; 707/104.1

(57) ABSTRACT

A method of reviewing inventions using a review board made up of two or more members to determine a final disposition for the invention such as retaining the invention as a trade secret or filing a patent application for the invention. The review is conducted so that no unacceptable comments are made about the inventor or his/her invention. The method further involves identifying problems solved by the invention, identifying the elements of the invention in view of the problems and then drafting a claim in view of the elements. The claim is modified during the review process based on one or more parameters such as business value, prior art and operability of the invention. The review process may be performed by a computer program including user interfaces that facilitate review of the invention and determination of a final disposition for the invention.

This application is a divisional of U.S. Nonprovisional patent application Ser. No. 10/457,690, filed on Jun. 9, 2003, and titled “Invention Review Board System and Method,” that claims the benefit of U.S. Provisional Patent Application No. 60/388,344, filed Jun. 13, 2002, each of which application is incorporated herein by reference in its entirety.

### FIELD OF THE INVENTION

The invention relates to an invention review process for facilitating a group decision in a multidisciplinary group about the disposition of an invention, e.g., an invention as described in an invention disclosure document. The invention also relates to a software system for automating the invention review process.

### BACKGROUND OF THE INVENTION

The patent application process has become increasingly expensive in recent years. Pursuing a patent application that does not support one's business strategy, or a patent application that does not result in sufficiently broad claims, can waste tens or even hundreds of thousands of dollars.

Most companies make decisions about filing patents in an ad hoc manner without any pre-defined criteria or strategy, such as pre-defined disposition criteria and/or a pre-defined strategy or set of criteria, to assist in the decision making process. Typically, an employee presents an invention disclosure to a manager. The manager decides whether or not to present it to his or her manager. Somewhere along the line, a decision is made to send the invention disclosure to a patent attorney for a prior art search and an assessment of patentability.

In this ad hoc process, there is no opportunity for a multidisciplinary meeting of the minds or a systematic evaluation and enhancement of the invention. The present invention solves these problems by providing a method of systematically and collaboratively reviewing an invention and making a decision regarding its disposition based on pre-defined disposition criteria and strategy.

### SUMMARY OF THE INVENTION

In one implementation, the present disclosure is directed to a system for reviewing an invention by at least one reviewer. The system includes: a computer database; a problem interface configured to prompt the at least one reviewer to input into the problem interface one or more technical problem statements and one or more business problem statements directed to the invention and to store the technical and business problem statements in the computer database; an element interface configured to prompt the at least one reviewer to input into the element interface elemental descriptions of the invention as a function of ones of the technical and business problem statements stored in the computer database and to store the elemental descriptions in the computer database; and a claim generator configured to automatedly generate an initial patent claim for the invention using ones of the technical and business problem statements stored in the computer database and using ones of the elemental descriptions corresponding to the ones of the technical and business problem statements used by the claim generator to generate the initial patent claim.

In another implementation, the present disclosure is directed to a system for reviewing an invention by at least one reviewer using a machine. The system includes: first means for storing digital data; second means for prompting the at least one reviewer to input into the machine one or more technical problem statements and one or more business problem statements directed to the invention and for storing the technical and business problem statements in the first means; third means for prompting the at least one reviewer to input into the machine elemental descriptions of the invention as a function of ones of the technical and business problem statements stored in the first means and for storing the elemental descriptions in the first means; and fourth means for automatedly generating an initial patent claim for the invention using ones of the technical and business problem statements stored in the first means and using ones of the elemental descriptions corresponding to the ones of the technical and business problem statements used by the fourth means to generate the initial patent claim.

In still another implementation, the present disclosure is directed to a machine-readable media containing machine-executable instructions for performing a method of reviewing an invention by at least one reviewer. The machine executable instructions include: a first set of machine-executable instructions for prompting the at least one reviewer to input into a machine one or more technical problem statements and one or more business problem statements directed to the invention and for storing the technical and business problem statements on the machine; a second set of machine-executable instructions for prompting the at least one reviewer to input into the machine elemental descriptions of the invention as a function of ones of the technical and business problem statements stored in the first means and for storing on the machine the elemental descriptions; and a third set of machine-executable instructions for automatedly generating an initial patent claim for the invention using ones of the technical and business problem statements stored on the machine and using ones of the elemental descriptions corresponding to the ones of the technical and business problem statements used by the third set of machine-executable instructions to generate the initial patent claim.

In yet another implementation, the present disclosure is directed to a method of reviewing an invention by at least one reviewer. The method includes: prompting the at least one reviewer to input into an invention-review machine one or more technical problem statements and one or more business problem statements directed to the invention; prompting the at least one reviewer to input into the invention-review machine elemental descriptions of the invention as a function of ones of the technical and business problem statements stored on the invention-review machine; and automatedly generating an initial patent claim for the invention using ones of the technical and business problem statements input into the invention-review machine and using ones of the elemental descriptions corresponding to the ones of the technical and business problem statements.

### BRIEF DESCRIPTION OF THE DRAWINGS

For the purpose of illustrating the invention, the drawings show one or more forms of the invention. However, it should be understood that the present invention is not limited to the precise arrangements and instrumentalities shown in the drawings, wherein:

FIG. 1 is side elevation view of a wheelbarrow used as an example in connection with a description of the method of the present invention;

FIG. 2 is a depiction of elements used in an example of the business-technical scale analysis of the method;

FIG. 3 is a depiction of elements used in an example of the elements listing step of the method;

FIG. 4 is a depiction of a reverse morphological matrix of the method;

FIG. 5 is an invention listing user interface for a software program usable to facilitate the method;

FIG. 6 is a problem solved user interface for a software program usable to facilitate the method;

FIG. 7 is an element list user interface for a software program usable to facilitate the method;

FIG. 8 is a reverse morphological matrix user interface for a software program usable to facilitate the method;

FIG. 9 is a generalized claim user interface for a software program usable to facilitate the method;

FIG. 10 is a prior art user interface for a software program usable to facilitate the method;

FIG. 11 is a value user interface for a software program usable to facilitate the method;

FIG. 12 is a technical operability user interface for a software program usable to facilitate the method;

FIG. 13 is a modified claim user interface for a software program usable to facilitate the method;

FIG. 14 is a disposition user interface for a software program usable to facilitate the method;

FIG. 15 is a report generation user interface for a software program usable to facilitate the method; and

FIG. 16 is a block diagram showing the relational structure of a software program usable to facilitate the method.

### DETAILED DESCRIPTION OF THE INVENTION

The invention provides a collaborative invention review method for evaluating and assigning a disposition to an invention. The invention also includes a software system for automating the invention review method.

### Participants

In the invention review method that follows, various participants work together to evaluate an invention and assign a disposition to the invention. The participants each play one or more specific roles in the invention review method. The typical roles are: facilitator, technical expert, business expert, and legal expert. Ideally, a specific participant plays a single role; however, it is possible within the scope of the invention for a single participant to play multiple roles. For example, a single participant may play the technical expert role and the business expert role, or the facilitator role and the business expert role.

A participant who has been trained to facilitate the method of the invention plays the role of facilitator. The facilitator is preferably an objective third-party consultant, who is not a member of the entity holding the review board. However, the facilitator may be a member of the entity holding the review board. In an alternative embodiment of the invention, the facilitator may be played by a computer programmed to elicit responses from the participants according to the method of the invention.

A participant who is familiar with the technical aspects of the invention plays the role of technical expert. The technical expert role is typically played by one or more participants associated with the conception of the invention and/or having intimate knowledge of the invention, such as one or more inventors. The technical expert role may sometimes be divided into sub-roles. Preferably, these sub-roles include an “inventor” role and an “advocate” role, each played by a separate participant. The “inventor” role is typically played by one or more participants associated with the conception of the invention and/or having intimate knowledge of the invention, such as one or more inventors. The advocate role is preferably played by a participant with skill in the art to which the invention pertains who was not associated with the conception of the invention.

The business expert role is preferably played by a participant having intimate knowledge of the business strategy of the company or company sub-unit from which the invention has been generated. The business expert is expected to have the ability to discuss whether intellectual property generated by the invention is in line with the strategy of the company or company sub-unit.

The legal role is played by one who has expert knowledge in patent law and who is licensed to advise clients regarding legal matters. This participant should be a patent attorney or patent agent.

In the text that ensues, the method is described in relation to the foregoing roles. It should be understood that reference to a role is not necessarily a reference to a specific participant, since one participant may play more than one role. The minimum number of participants in the process is two. For example, one participant may play the facilitator role, the technical role and the business role, while another participant plays the legal role. Similarly, one participant may play the technical role and the business role, while another plays the legal role and the facilitator role.

### Decision Making Steps

The invention review method of the invention includes various decision-making steps, such as decisions about when a step is complete, when to move to the next step, and the like. Any step requiring a decision can be made using a variety of decision-making techniques. For example, the decision may be made by voting of some or all participants, decision of the facilitator, decision of a senior member of the participants, and the like. Typically, the method of decision-making should be identified in advance of the specific decisions in question.

### Invention Review Board Method

In the invention review board method, the participants collaborate to assign a disposition to one or more inventions. In one embodiment, some or all of the participants are gathered together, e.g., in single room, and the review board method proceeds as an ordinary structured meeting. In another embodiment, the participants may be physically separated, and communications may take place via various electronic means, such as telephone, fax, a network like the Internet, or email.

The basic steps of the method are as follows:
(1) Setting the climate
(2) Introducing the participants to the invention (preliminary step)
(3) Identifying a series of problems along a business-technical scale that are solved by the invention
(4) Selecting a technical problem from the series of problems
(5) Listing the elements that were used to solve the technical problem
(6) Using a reverse morphological matrix to identify broad terms corresponding to the elements
(7) Using the broad terms to produce a rough draft of a claim
(8) Comparing the rough draft claim to known prior art
(9) Narrowing or expanding the rough draft claim as needed to define a set that excludes prior art
(10) Evaluating the business value of the claim
(11) Evaluating the technical operability of the invention
(12) Evaluating disposition issues
(12) Assigning a disposition to the invention

The steps may be carried out in any logical order. For example, it is possible to switch steps 9 and 10 without impeding the logical flow of the process. The ensuing sections elaborate upon these basic steps and their alternatives.

### Setting the Climate

The first step is, prior to the review of the invention, the technical participant, preferably the participant playing the inventor role, is introduced to the other participants, who constitute the review team. The participants are advised not to make unacceptable comments about the inventor or the invention. Typically, the facilitator will provide this advice, although other participants may also provide such advice. What constitutes an unacceptable comment is subjective to some extent, and will be based on the emotional makeup of the inventor, the attitude and sensitivity of the participants, the norms for the business or other entity in which the invention is being reviewed, and other factors. Comments that make the inventor lose interest in participating in the invention review process in the future, involve personal attacks on the character or other attribute of the inventor, or involve criticism of the invention beyond that necessary to perform the method described below, are all examples of unacceptable comments. During the invention review process, the facilitator or other participant should monitor the interaction of the review board team and should, if either the inventor or facilitator observes unacceptable comments being made, take action. This action may include reminding the participants not to make unacceptable comments, temporarily suspending the process, or stopping the process and rescheduling with different team members. Other actions may also be taken, as the review board deems appropriate.

### Introducing the Participants to the Invention

The process includes introducing the participants to the invention. This step may be accomplished prior to the actual review board session, or it may take place during the review board session.

In the typical invention review board, the invention is introduced to the participants by way of an invention disclosure document. Preferably the disclosure document is drafted and distributed to the participants for review prior to the initiation of the review board.

When introducing the invention at the review board session, the technical expert, often an inventor, describes the invention to the other participants. The other participants may ask questions and generally discuss the invention to ensure that they have an understanding of the invention.

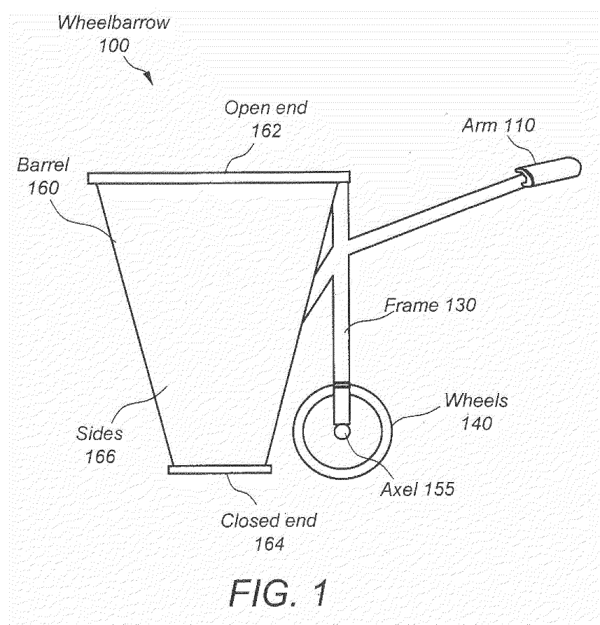

In the ensuing description of the review board method, the invention is described in reference to a hypothetical wheelbarrow invention, shown in FIG. 1, as an example of how the method may be performed. The background and detailed description sections of a disclosure for the wheelbarrow invention might read as follows:

### Wheelbarrow Example: Background

Wheelbarrows provide the essential function of aiding manual transportation of heavy materials such as earth and stone, as well as bulky materials such as wood and garden waste.

As the construction industry remains the primary consumers of wheelbarrows, focusing designs and marketing on the needs of the construction firms will likely increase sales and increase the overall market share in this multi-million dollar industry.

The single front-wheeled wheelbarrow design remains the most popular in construction use. Unfortunately, most present-day construction wheelbarrows have a large turning radius and are easy to tip because of the location of the center of gravity relative to the handles and wheels. These design properties are less than ideal for employing a wheelbarrow in certain locations, such as high-rise construction sites and on narrow walkways.

### Wheelbarrow Example: Description of the Invention

The present invention is a wheelbarrow for efficiently transporting heavy material by providing the wheelbarrow with a wide rear wheelbase, rear handles, and a low center of gravity.

FIG. 1 illustrates the design of a wheelbarrow according to the present invention. Wheelbarrow 100 includes an arm 110 attached to a top edge of frame 130. Frame 130 is orientated perpendicular to the ground. Wheelbarrow 100 further includes a pair of wheels 140, rotatably attached, one at each end of an axle 155. Axle 155 passes through a bottom portion of the frame 130. Arm 110 is positioned above wheels 140. Arm 110 and wheels 140 are located on the same side of wheelbarrow 100. Arm 110 is angled upwards and away from wheels 140.

Wheelbarrow 100 further includes a barrel 160 attached to the top edge of frame 130 opposite arm 110. Barrel 160 includes sides 166, an open end 162, and a closed end 164. The center of gravity of wheelbarrow 100 is located between closed end 164, open end 162 and sides 166 when wheelbarrow 100 is empty or partially filled. However, with loads that overflow barrel 160, it is possible for the center of gravity of barrel 160 to be above the open end 162 relative to the ground.

Closed end 164 of barrel 160 contacts the ground when wheelbarrow 100 is stationary. To move wheelbarrow 100, a user grasps arm 110 and applies force in a downward direction. This action lifts closed end 164 off the ground and tilts wheelbarrow 100 toward the user. Wheelbarrow 100 is supported by wheels 140 at this point. While maintaining downward force the user exerts forward force on arm 110 to move wheelbarrow 100. Because wheels 140 are close to arm 110, the turning radius of wheelbarrow 100 is very tight. For this same reason and also because there are a pair of wheels, wheelbarrow 100 is less likely to tip than standard single wheel wheelbarrows having the wheel located on the other side of the container from the handles.

### Identifying Problems

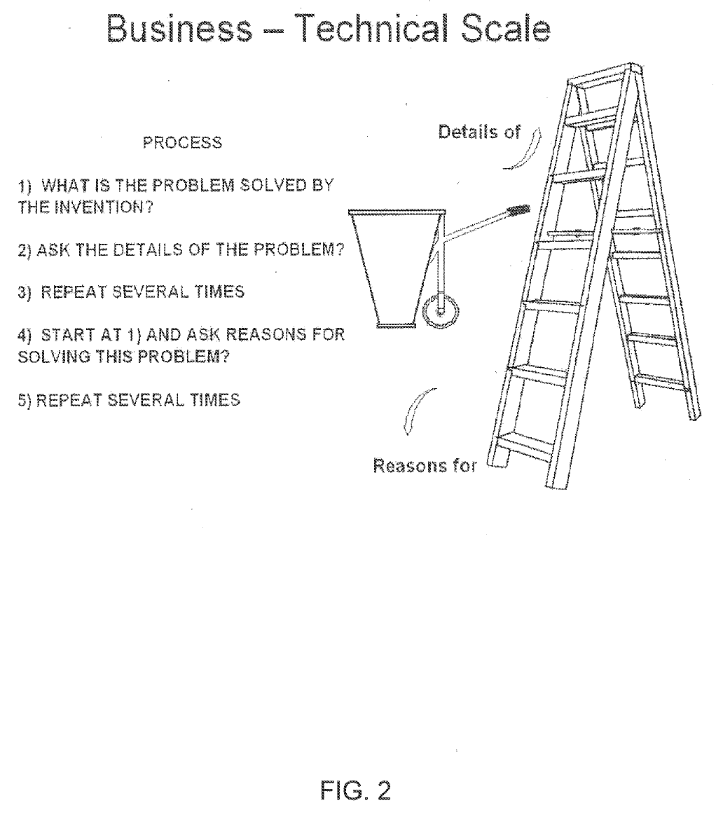

The participants collaborate to identify the technical problem or problems solved by the invention. To identify the technical problem(s) solved by the invention, the facilitator uses a thinking tool, referred to as the business-technical scale. The objective of this step is to establish a series of problems ranging from broad business problems to narrow technical problems that are solved by the invention. FIG. 2 illustrates this concept using the illustration of a novel wheelbarrow.

The business technical scale helps to flesh out the participants' understanding of the problems solved by the invention by eliciting from the inventor a series of problem statements that vary from broad business reasons to narrow technical reasons. The facilitator asks the inventor “What is the problem solved by the invention?” If the facilitator wishes to identify more generalized or abstract problems, the facilitator asks the inventor “What are the reasons for solving the problem?” These may also be in the form of “why” type questions, e.g., “Why do you want to solve the problem?” If the facilitator wishes to identify more technical problems, the facilitator asks the inventor “What are the details of solving the problem?” These may also be in the form of “how” type questions, e.g., “How did you solve the problem?”

Referring to FIG. 2, asking an inventor “What is the problem solved by the invention?” might result in the answer, “We wanted to improve safety.” Lack of safety is not a technical problem. It is a business and ethical problem. To move the inventor to a more technical problem, the facilitator might ask, “How did you improve safety?” In response, the inventor might respond “I made the wheelbarrow more stable,” which is the corollary of the problem “We wanted to make a more stable wheelbarrow.” Asking further “details of” or “how” type questions would lead to a series of narrower solutions, each of which is the corollary of a problem.

In another case, asking an inventor “What problem does the invention solve?” might result in the answer, “We wanted to provide a new frame design.” Asking “details of” or “how” type questions leads to narrower problems, like “We wanted to make the bucket rest on the ground,” and “We wanted the wheels and the bucket to rest on the same plane.” Asking “reasons for” or “why” type questions leads to broader business problems, like improving safety, reducing insurance costs, and increasing profitability.

### Selecting Technical Problem(s)

Once the participants have established a set of problems that range along the business-technical scale, the participants select one or more technical problems as the basis for identifying elements and drafting a claim. The technical problem(s) to be pursued may, for example, be selected by vote, by group consensus, or one of the participants may choose the problem, e.g., the facilitator or the highest-ranking participant may be vested with the power to select the technical problem(s). The problem(s) should be technical and not business problems. The problem(s) should include one or more primary problems solved by the invention. For example, in the wheelbarrow example, the participants might select, by consensus, the following problems: (1) prior art wheelbarrows are easy to tip and (2) they have large turning radiuses.

### Listing Elements

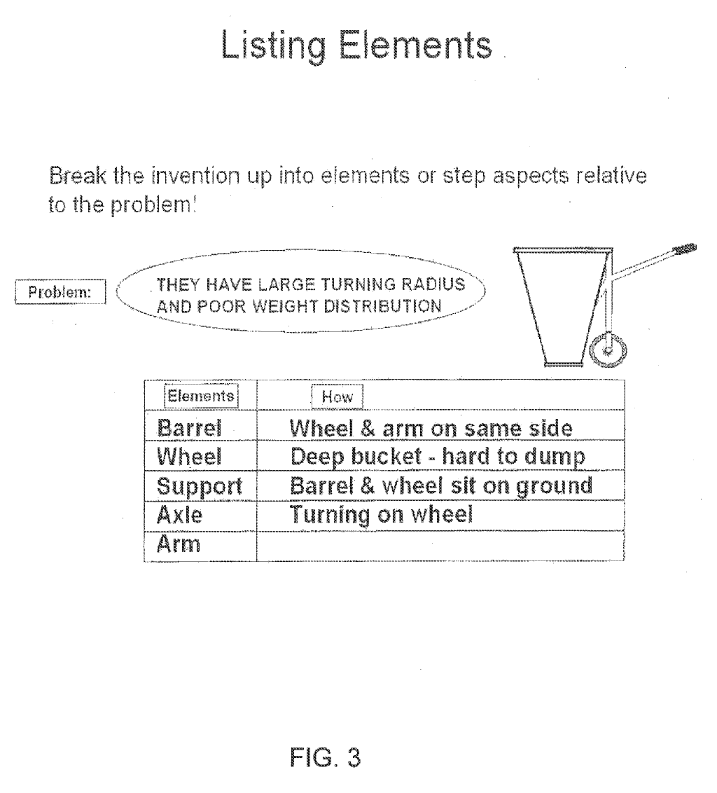

Next, one or more of the participants identify the elements of the invention that were used to solve the technical problem(s). The elements can be derived from a disclosure, ascertained by the group from the description given by the technical expert, identified by the technical expert, or the like. In the wheelbarrow example, the elements might be listed as barrel, wheels, frame, axle, and arm (see FIG. 1: barrel 160, wheels 140, frame 130, axle 155, arm 110). For process inventions, the elements will be the various steps of the process. The facilitator lists the elements of the invention, preferably across the top of a table, as shown in FIG. 3.

### Identifying Broad Terms

Next, the participants use a reverse morphological matrix to identify broad terms for use in the claim. The reverse morphological matrix provides a method of identifying broad generic terms that encompass sets of specific terms. The participants start with the specific element listed in the preceding section and brainstorm alternative elements. Next, the participants seek to identify a general term that encompasses the specific terms. For example, using the wheelbarrow example, when asked to identify alternative elements for “barrel,” the participants might list holders, cans, cylinder, and boxes. When asked to identify a single term that describes all of the listed elements, the participants might identify the word, “container.”

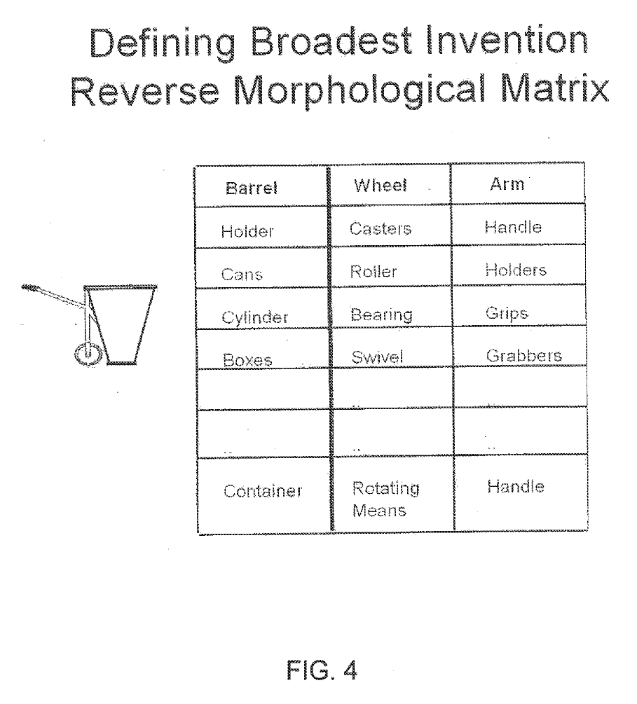

To facilitate the reverse morphological matrix step, the facilitator may wish to draw a table and list the elements across the top of the table, or list the elements on such a substrate without a table. This step can be accomplished using a white-board, chalk board, flip chart, paper, or the like. A particularly helpful way to facilitate the reverse morphological matrix is by drawing a table in a word processor, and displaying the table in a manner that permits the table to be viewed by some or all of the participants as it is modified. Alternative elements can be listed underneath the original element. Broad terms encompassing the alternative elements can be listed at the bottom. FIG. 4 illustrates the use of such a table.

### Producing Claim(s)

Next, the participants work together to use the broad terms to draft a claim. A useful way to do this is to list a business or technical reason, the elements, and how the elements are connected and/or arranged.

For example, in the wheelbarrow example, the facilitator might initially write the following claim outline:

A container for use in high-rise construction comprising:
container
wheel and axel
support joining axle to barrel
arm for handling and tipping barrel
wheel & arm on same side
deep bucket—hard to dump
barrel & wheel sit on ground
turning on wheel

### Comparing the Claim Outline to Prior Art

Next the participants compare the elements of the claim outline to the prior art known to the participants. In regard to this parameter with which the claim elements are compared, it is helpful to make a grid for listing similarities and differences in elements and connections between the elements. The following table is an example:

| Invention Elements: | Elements Known in Prior Art: |
|---|---|
| Barrel | Barrel |
| Wheel | Wheel |
| Support | Support |
| Axle | Axle |
| Arm | Arm |
| Arrangement of the | Arrangement of the Prior |
| Invention Elements: | Art Elements |
| Wheel & arm on same side | Wheel & arm on opposite side |
| Deep bucket - hard to dump | Wide bucket |
| Barrel & wheel sit on ground | Frame and wheel sit on ground |
| Turning on wheel | Large turning radius |

Such a table may, for example, be drawn on a substrate for viewing by the participants. One embodiment of the invention review method involves preparing the table for display using a computer display device, such as a monitor or a PC projector. The table may, for example, be prepared using a word processor or spreadsheet. Note that in the wheelbarrow example, all of the parts of the wheelbarrow are known in the prior art. The differences are found in the arrangement of the parts.

### Narrowing the Claim Outline

The participants collaborate to refine the claim outline to create one or more rough claims. In particular, the participants seek to refine the claim outline to logically define a set that excludes the prior art known to the participants, as identified in Step 0, “Comparing the Claim Outline to Prior Art.”

For example, the participants might capitalize on the unique features of the wheelbarrow invention to define claim outlines focused on the following unique features: wheel & arm on same side, and barrel & wheel rest on ground.

The first claim outline might read as follows:

A container for use in high-rise construction comprising:
container
wheel and axel
support joining axle to barrel
arm for handling and tipping barrel
where the wheel and arm are mounted on the same side of the barrel

The second claim outline might read as follows:

A container for use in high-rise construction comprising:
container
wheel and axel
support joining axle to barrel
arm for handling and tipping barrel
where the barrel & wheel are arranged so that both rest on ground

These claim outlines exclude the prior art known to the participants. While they need the work of a patent attorney or agent to refine them into claim language that comports with the various requirements of 35 U.S.C. § 112, they are sufficient to enable the participants to assess, within the limitations of the review board, the probable scope of the intellectual property. In one embodiment, the participants work with the legal expert to further refine the claims to comport with the legal requirements and traditional style of a patent claim.

### Evaluating Value

Next the participants evaluate the business value of the invention as represented by the claim outline(s). The parameter of business value may be represented in the form of an intellectual property strategy grid that establishes objective criteria for inventions that will support the business strategy of the company. However, in the absence of such a strategy grid or other set of decision-making criteria that are specific to the company, a basic set of criteria may be quickly evaluated and agreed upon by the review board participants. For example, one set of useful criteria is illustrated in the following table:

| | | Review Board Analysis | | |
|---|---|---|---|---|
| | | | | Tech- |
| Function | Evaluation criteria | Legal | Business | nical |
| Business | Does the invention help to | | | |
| Development | develop an improved strategy | | | |
| | for dealing with licensing out? | | | |
| | Does the invention allow the | | | |
| | company to close a deal with a | | | |
| | licensee? | | | |
| Cost | Does the invention represent | | | |
| Management | an incremental improvement | | | |
| | that can be published to protect | | | |
| | core IP, to defray patent costs, | | | |
| | or to be used in our licensing | | | |
| | story? | | | |
| Strategic | Does the invention relate to | | | |
| | core expertise, know-how, and | | | |
| | confidential subject matter? | | | |
| | Does the invention support a | | | |
| | long-term patent strategy | | | |
| | (fundamental IP)? | | | |
| | Does the invention support a | | | |
| | short-term “know how” story | | | |
| | for immediate licensing | | | |
| | stories? | | | |
| | Does the invention anticipate a | | | |
| | customer need (through IP | | | |
| | and/or know-how) that | | | |
| | enhances the company's ability | | | |
| | to control its product space? | | | |
| | Does the invention provide an | | | |
| | opportunity to patent, then | | | |
| | publish without loss of further | | | |
| | IP? | | | |
| | Does the invention provide an | | | |
| | opportunity to present strategic | | | |
| | topics at key conferences? | | | |
| | Does the invention provide a | | | |
| | competitive advantage? | | | |

The analysis can proceed in a number of different ways. At its simplest level, the participants simply answer yes or no, and the exercise is used to bring to the minds of the participants important issues for their decision-making process. At a more complex level, the participants can assign a score, e.g., on a scale of 0-4, where 0 means strongly disagree and 4 means strongly agree. A set of inventions can be reviewed and scored, and the inventions can be ranked according to the relative score. An important aspect of the invention is that at least two different participants score the inventions, preferably one participant plays a business and/or technical role, and another plays a legal role. In one embodiment, at least one participant in each of the technical, business and legal roles reviews the invention.

### Evaluating Operability

Next, the participants evaluate the parameter of technical operability of the invention. This step is designed to elicit sufficient information to determine whether the invention is operable. The participants discuss the operability issues of the invention to inform their understanding of the value of the invention. The analysis of operability may be structured such that a binary result, i.e., operable or not operable, is used. Alternatively, the operability analysis may be more refined and take into consideration other factors such as efficiency of operation, cost of operation, tolerances of operation and the like. This operability step can be combined with the preceding business value evaluation step. If necessary, the participants work together to modify the invention to overcome any operability issues.

### Evaluating Disposition Issues

Next, the participants evaluate disposition issues, i.e., parameters that influence whether the invention should be filed as a patent, trade secret or published as a defensive publication.

Examples include:
Is the cost of patenting justified by the benefit of the anticipated patent claim?
Can the invention be protected in a manner that is sufficiently secure to support trade secret protection?
Does the invention embody a high degree of complexity and novelty that would make independent invention by a competitor unlikely?
Are the novel aspects of the invention embodied in a form that would permit the invention to be reverse engineered?
Is the company committed to taking the steps that are necessary to protect the invention as a trade secret?
Is the invention a core or platform technology with multiple applications?
Is the invention an improvement to a core technology that is not already protected by patent?
Is the invention an improvement to patented inventions in a field where patent term is important?
Is the invention an incremental invention that is covered by existing patent claims and is not embodied in a product with potentially long-term marketability?
Does the invention appear to be a strong candidate for patent protection?

### Assigning a Disposition

Based on the answers to the questions in the foregoing steps, and in light of pre-defined disposition criteria the participants assign a disposition to the invention. Examples of dispositions include: file provisional patent application, file regular patent application, file international patent application, maintain invention as a trade secret, publish invention as a defensive publication, do further research to confirm proof of concept, and the like.

### Invention Review Board System

The review board method of the invention may be supported by software. A preferred software system provides a series of user interfaces that prompt the participants for input, and stores the input in a database. The software is designed to be executed by a general-purpose digital computer (not shown) having logic (e.g., a microprocessor), transient memory (e.g., RAM), persistent memory (e.g., optical or magnetic disk memory), access devices (e.g., keyboard and mouse), and a device for displaying user interfaces provided by the software (e.g., a monitor). The computer may be operated on a stand-alone basis or as part of a local, wide or global computer network.

In one embodiment, the system displays the following series of user interface screens:
1. Interface for entering inventions to be reviewed
2. Interface for entering problems along business-technical scale
3. Interface for listing elements
4. Interface for reverse morphological matrix step
5. Interface for drafting first claim outline
6. Interface for comparing first claim outline to known prior art and drafting second claim outline
7. Interface for voting on the value of the invention
8. Interface for voting on the technical operability of the invention
9. Interface for modifying the claim to overcome technical operability issues
10. Interface for voting on and/or inputting invention disposition
11. Interface for generating reports

The system is described in terms of a series of interfaces. It will be appreciated that any one or more interfaces, especially adjacent interfaces, may be combined. In fact, in one embodiment, the entire set of interfaces is combined into a single interface.

### Invention Entry Interface

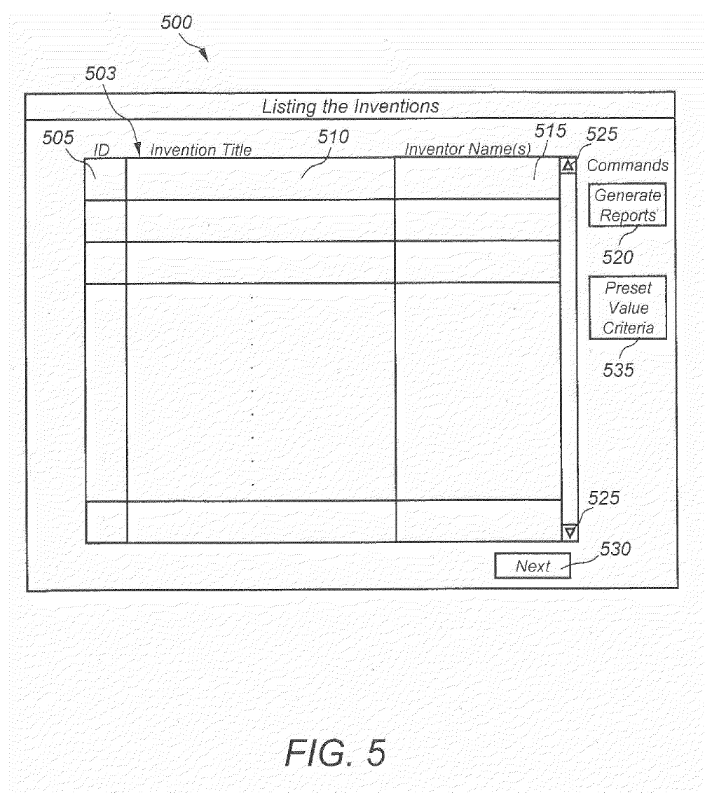

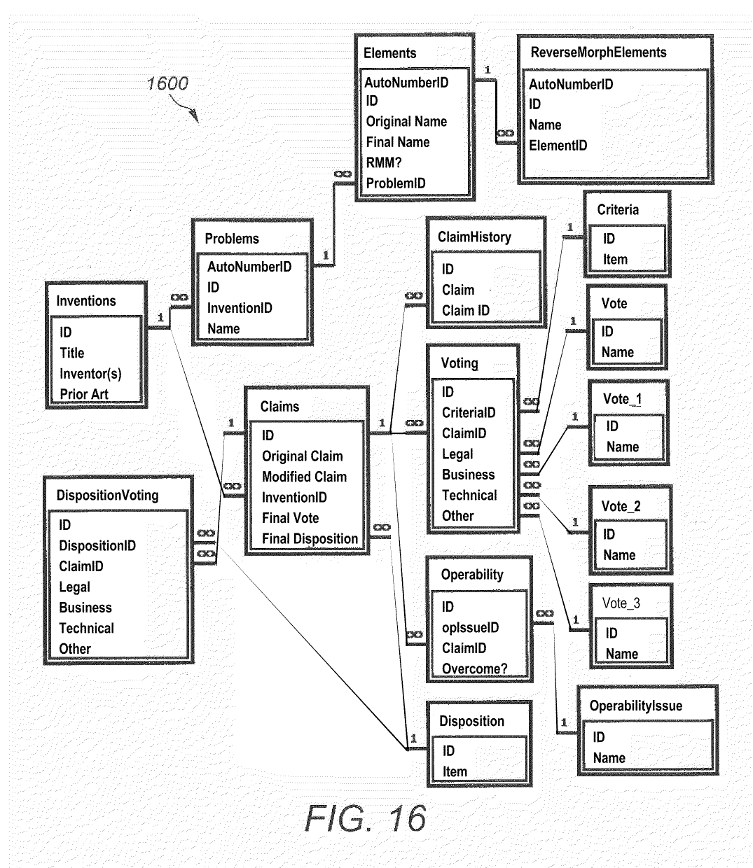

The system includes an interface for entering inventions to be reviewed. FIG. 5 illustrates an exemplary embodiment of an interface 500 for entering inventions to be reviewed. Interface 500 is programmed to accept input and store the same to a database (not shown), such as a Microsoft Access® database. The database structure preferably has a relational data structure (see FIG. 16).

Interface 500 is preferably programmed to display data input fields for entering the title(s) of invention(s) to be reviewed and names of probable inventor(s). Interface 500 includes an invention title table 503 having an identification (ID) column 505 with text input fields for inputting a unique identifier, e.g., an alphanumeric character, for each entered invention title, an invention title column 510 with text input fields for entry of invention title(s), and an inventor name(s) column 515 with text input fields for entry of inventor name(s) that correspond to each entered invention title. Interface 500 further includes a navigation button 530 that permits a user to navigate to a next interface, and preferably includes one or more additional on screen buttons for generating reports, such as generate reports button 520, and an on screen button for presetting value criteria, such as preset value criteria button 535. Interface 500 also includes scroll buttons 525 to allow a user to scroll through the list of entered invention records. In one example, scroll buttons 525 are represented as up and down arrows.

In operation, a participant(s) enters the title of each invention to be reviewed into invention title column 510, a unique identifier into ID column 505, and the inventor name(s) corresponding to the entered invention in inventor name(s) column 515. It should be noted that in an alternative embodiment the unique identifier may be automatically generated and entered into ID column 505 for each invention title record. Interface 500 may optionally include an input field (not shown) for entering the names of the members of the participants assigned to review the invention.

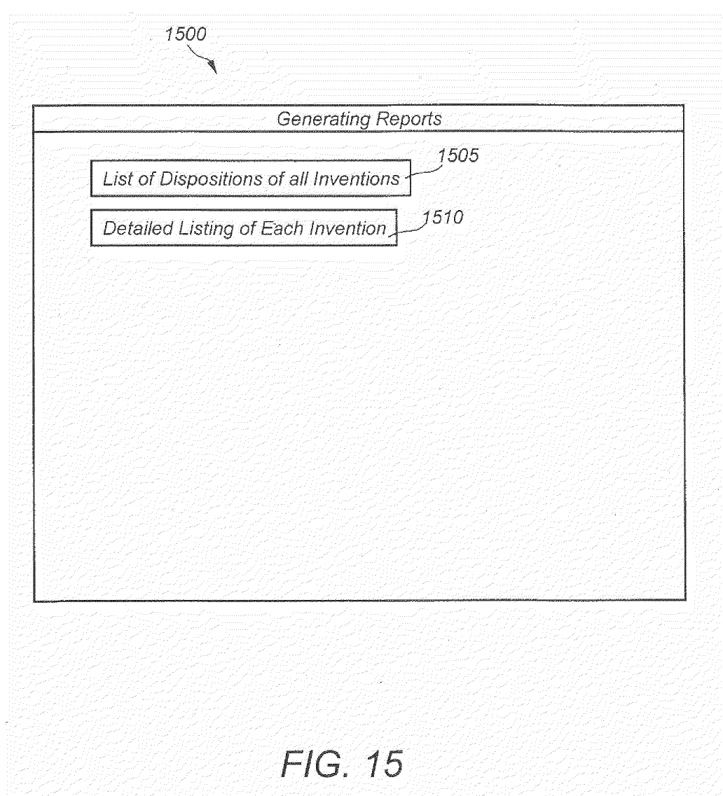

After the participant has entered the invention(s) to be reviewed, the participant may select a specific entered invention record to be reviewed either by clicking directly on the selected invention or by using scroll buttons 525 to scroll through the list of entered invention records and selecting the desired invention record. In an alternative embodiment, an input field may be provided to enable the participant to input the unique identifier of the invention record to be reviewed. Once the invention record is selected, the participant clicks on navigation button 530 to navigate to a next interface 600 for entering problems along the business-technical scale that relate to the selected invention record. Optionally, the participant may select generate reports button 520, which navigates to report interface 1500 (see FIG. 15) to generate one or more reports including the data saved to the database.

### Problem Interface

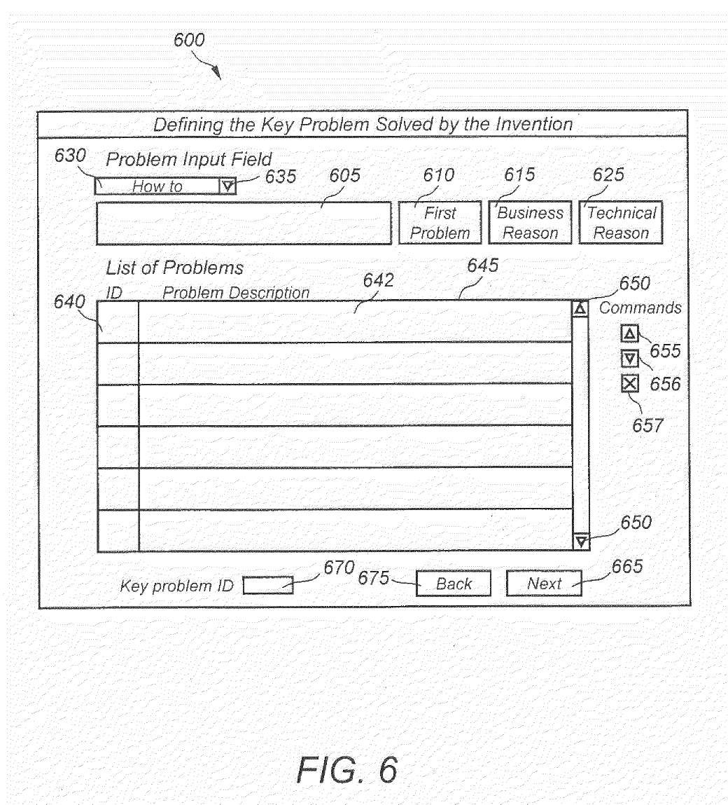

The system includes an interface for entering problems along a business-technical scale, as described above in the section entitled “Selecting Technical Problem(s).” FIG. 6 is an illustration of an exemplary embodiment of an interface 600 for entering problems along the business-technical scale. Interface 600 is programmed to accept input and store the same to a database, such as that described above in the section entitled “Invention Entry Interface.”

In operation, a participant enters a first problem statement into a problem input field 605. The problem statement is preferably phrased in the interface as a “How to” (H2) type question. The participant may select a “how to” type prefix from a prefix combo box 630 allowing for the “how to” type prefix to automatically be inserted at the beginning of the problem statement. The participant may alternatively select a different prefix, such as “when to,” “how do I,” etc., using prefix combo box arrow 635. The prefix may be previously loaded in to prefix combo box 630, or directly entered by the participant in to prefix combo box 630. Once the participant has entered the problem statement into problem input field 605, the participant selects first problem button 615, which stores the problem statement to the first row in problem table 645.

Once the first problem statement is entered, the participant is prompted by a facilitator or by the software system of the invention for the business and/or technical reasons behind the problem statement to move up and down the business-technical scale. The participant enters each business and/or technical reason one at a time into problem input field 605 and selects business reason button 615 or technical reason button 625 based on whether a business or technical reason was entered. If business reason button 615 is selected, any rows in problem table 645 with existing data are demoted down one row, and the entered problem statement comprising the combination of prefix combo box 630 and problem input field 605 is stored to problem description column 642 in the first row of problem table 645. If technical reason button 625 is selected, the entered problem statement comprising the combination of prefix combo box 630 and problem input field 605 is stored to problem description column 642 in the first available row of problem table 645, which is the first row any rows with existing data. In this manner, business problem statements are inserted in the first row of the table, and technical problem statements are inserted in the first available row of the table.

In the case of business reasons, the participant preferably enters no more than three business reasons, with each having a higher level of abstraction than the last. In the case of technical reasons, the participant preferably enters no more than three technical reasons, with each increasing in detail. The present invention, however, encompasses entering lesser or greater numbers of business and technical reasons than three.

Preferably the business reasons are ordered by level of abstraction, e.g., having the highest level at the top of problem table 645, and having the technical reasons ordered by level of detail, e.g., having the most detailed at the bottom problem table 645. Buttons, such as up/down arrows 655, 656 and delete 657 may be provided to enable the user to re-sort and/or delete entered problems statements. Interface 600 additional has a scroll arrows 650 that allow the participant to scroll through and view all the problems entered in problem table 645.

As each problem statement is entered into a row in problem table 645, a unique identifier, such as an alphanumeric character, is assigned and written to ID column 640 in the corresponding row. The unique identifier may be entered by the participant or auto generated by the software system of the invention.

Once the problem statements have been defined the participant selects from among the problem statements entered into problem table 645 the key problem solved by the invention, e.g., by selecting a single problem statement that is most closely related to the elements used in the invention. To select the desired problem statement the participant either clicks directly on the desired problem statement in problem table 645 or enters the problem's ID in to key problem ID field 670.

Additionally, navigation buttons 675 and 665 allow the participant to navigate back to the previous interface 500 and forward to interface 700, respectively. After the participant has selected the appropriate problem statement and entered the ID into key problem ID field 670, the participant selects navigation button 665, which navigates to a next interface 700 for listing the elements used to solve the problem of the selected invention record.

The interface is programmed to permit the participant to select a problem that will be the basis of the identification of elements. This problem is selected as described above in the section entitled “Selecting Technical Problem(s).”

### Element Interface

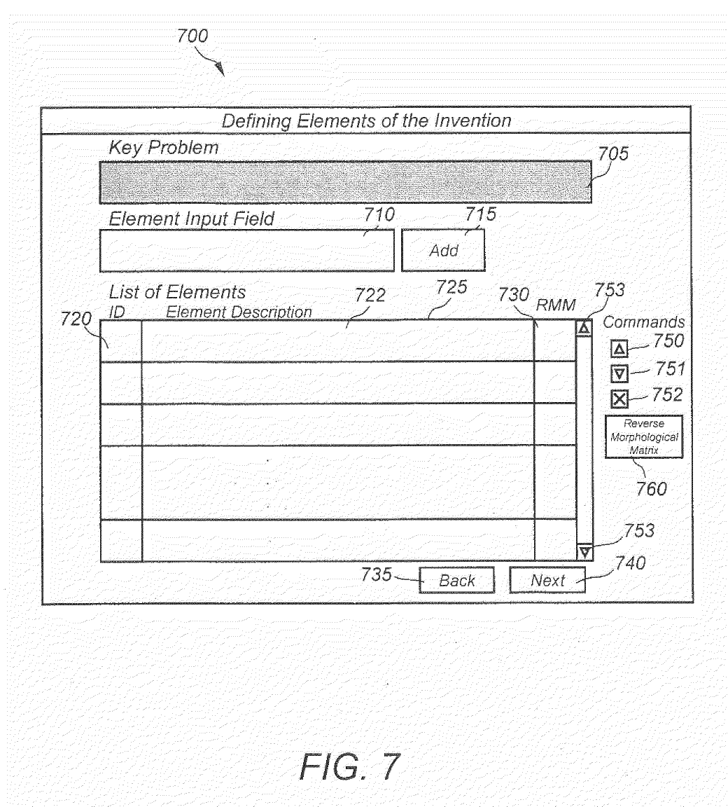

The system includes an interface for listing the elements that solve the problem, as described above in the section entitled “Listing Elements.” FIG. 7 is an illustration of an exemplary embodiment of an interface 700. The user accesses this interface by selecting navigational button 665 on the entering problems interface 600. The elements interface 700 displays the problem that was selected in the preceding step in a key problem field 705. Interface 700 permits the participant to enter elements that solve the problem into an element input field 710. When the element is entered, the participant selects add button 715 that stores the element into element description column 722 in the first available row of elements table 725 in the order in which it was entered. As each element is entered into elements table 725, a unique identifier, such as an alphanumeric character, is assigned and written to ID column 720. The unique identifier may be entered by the participant or auto generated by the software system of the invention.

Buttons, such as up/down arrows 750, 751 and delete 752 may be provided to enable the participant to re-sort and/or delete elements. Interface 700 additional includes scroll arrows 753 that allow the participant to scroll through and view all the elements entered in elements table 725. Additionally, navigation buttons 735 and 740 allow the participant to navigate back to the previous interface 600 and forward to interface 900, respectively.

Once the elements are entered in elements table 725, the participant may select an element from table 725 and then select reverse morphological matrix button 760 to navigate to interface 800 for entering alternative elements and/or alternative terms, and generic terms that encompass the alternatives for the selected element.

### Reverse Morphological Matrix (RMM) Interface

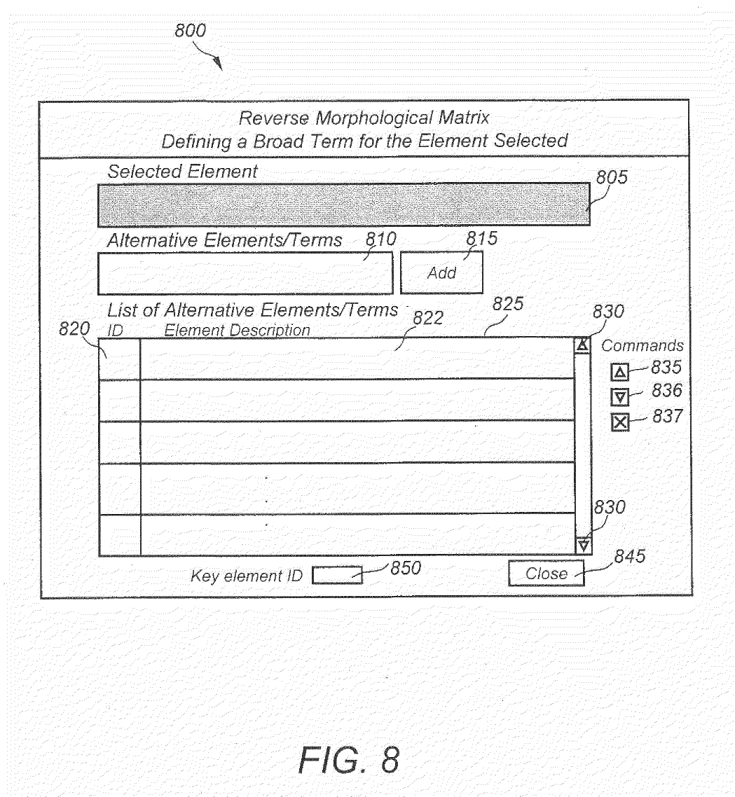

The system includes an interface for entering an alternative term for the element selected in elements interface 700. The RMM is described above in the section entitled “Identifying Broad Terms.” FIG. 8 shows an example of the RMM interface 800.

In operation, when the participant has selected an element and navigated from elements interface 700 to RMM interface 800 by selecting reverse morphological matrix button 760, the selected element is displayed in selected element field 805. The participant then enters alternatives, e.g., alternative elements and/or alternative terms for the selected element, and generic terms that encompass the alternatives into an alternatives input field 810.

The participant preferably enters an alternative element or term, or broad generic term, into alternatives input field 810 and selects add button 815, whereupon the alternative entered into alternatives input field 810 is stored to element description column 822 in the first available row in alternatives table 825.

As each alternative element is entered into alternatives table 825, a unique identifier, such as an alphanumeric character, is assigned and written to ID column 820. The unique identifier may be entered by the participant or auto generated by the software system of the invention.

Once the participant has entered sufficient alternative element terms, and has identified the broadest term listed, preferably one which is broad enough to encompasses the other alternative element terms entered, the participant enters its identifier into a key element ID field 850, and then selects close button 845 that returns the participant to interface 700. The alternative element is rewritten into elements table 725 and replaces the originally selected element from which it was morphed. Further a check or other indicator appears in RMM column 730 of the corresponding element row to indicate that the process incorporated in RMM interface 800 was executed to obtain the broadest generic term. This process incorporated in RMM interface 800 is repeated for each element listed in elements table 725.

Additionally, buttons, such as up/down arrows 835, 836 and delete 837 may be provided to enable the participant to re-sort and/or deleteentered alternatives. Interface 800 additional includes scroll arrows 830 that allow the participant to scroll through and view all the alternatives entered in alternatives table 825. Additionally, close button 845 closes interface 800 and returns to elements interface 700.

In an alternative embodiment, the alternative terms are loaded from a computer that is programmed with a specialized thesaurus that contains alternative elements and/or alternative terms. The system may include check boxes or other input fields or icons that permit the participants to keep or eliminate the terms suggested by the thesaurus. This data may be used to update the association of terms in the thesaurus, so that terms that are selected by the participants are ranked higher in subsequent operations, i.e., associations between terms may be strengthened or weakened by the input.

In yet another embodiment, a single RMM interface 800 may display all of the elements simultaneously and allow the participant to enter alternatives for all elements in one interface, e.g., each element may be listed across the top of interface 800 with data input fields for alternative and/or generic terms displayed underneath the elements, e.g., in a table format.

As will be described later, the system is programmed to use these elements to prepare one or more claim outlines.

### Claim Editing Interface

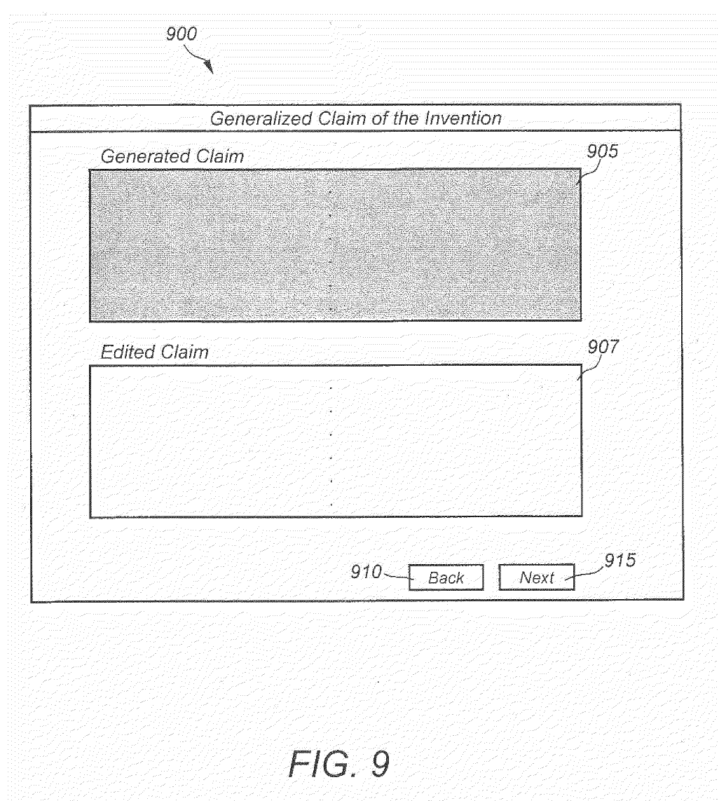

The system may include an interface for generating and editing a first claim outline. FIG. 9 shows an example of a first claim outline editing interface 900 for generating and editing a first claim outline. The system automatically generates the claim outline based on the information input in the previous interfaces. In general, editing is accomplished as described above generally in the section entitled “Producing Claim(s).”

First claim outline editing interface 900 includes a generated claim field 905, which is an un-editable field that lists the relevant problem statement(s) followed by the relevant elements from the previous interfaces. It is desirable at this stage for the participants to collaborate with the legal expert to refine the draft of the claim, using edited claim field 907, which is an editable field containing a copy of the text in generated claim field 905, to more fully comport with the requirements of patent law and traditional claims drafting approaches, e.g., by making sure that the claim is logically consistent and concise, and that the terms used are consistent and have antecedent basis.

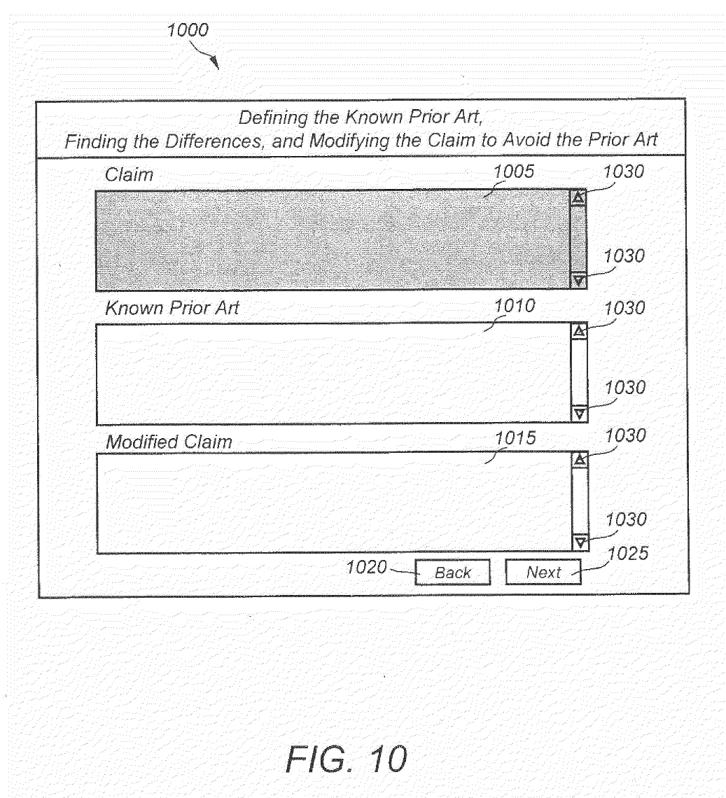

The first claim outline editing interface 900 preferably has a navigation button 915 for instructing the system to display the prior art comparison interface (see FIG. 10), and a navigation button 910 to return to the previous interface.

Upon completion of refining the draft claim outline, the participant selects navigation button 915 to navigate to interface 1000 for prior art comparison.

### Prior Art Comparison (PAC) Interface

The system includes an interface for comparing a first claim outline to known prior art and drafting a second claim outline, as described above in the sections entitled “Comparing the Claim Outline to Prior Art,” and “Narrowing the Claim Outline.” FIG. 10 shows an example of an interface 1000 for comparing a first claim outline to known prior art and drafting a second claim outline. PAC interface 1000 displays the first draft claim in an un-editable text field 1005 and provides an editable text field 1010 for entry of prior art known to the participants. PAC interface 1000 also displays the first draft claim in an editable format in text field 1015.

In operation, the participants list prior art known to them in prior art field 1010. The participants then compare the language of the first draft claim in text field 1005 with the known prior art in prior art field 1010 and, under the guidance of the legal expert participant, assess whether any specific instance of the prior art or any combination of the prior art logically encompasses the first draft claim in text field 1005. Based on this assessment and the guidance of the legal expert, the participants suggest revisions to the first claim that will logically exclude such prior art or prior art combinations, and edit the first claim in text field 1015 accordingly.

Note that the participants' assumptions about prior art may not be wholly accurate, and for this reason they are subject to further verification by patent counsel.

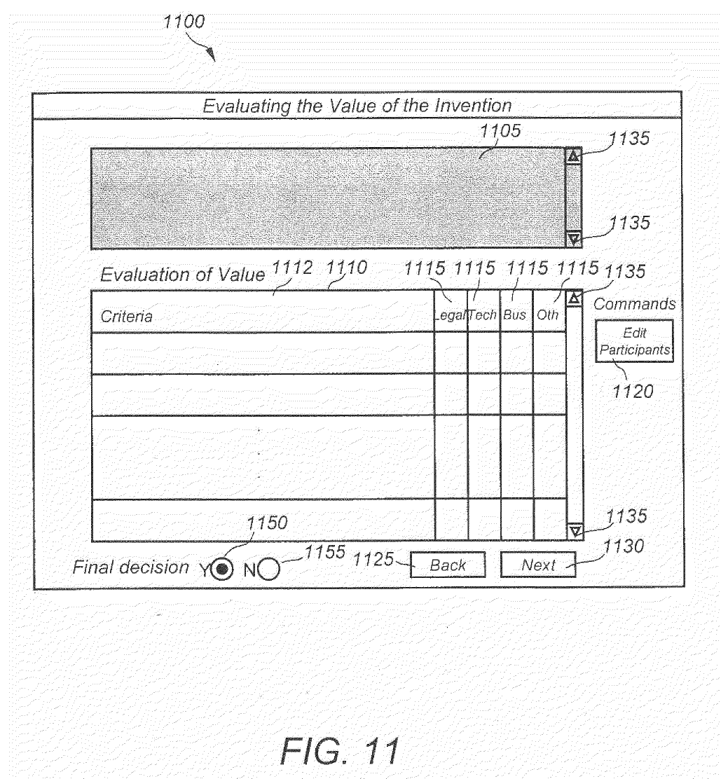

PAC interface 1000 includes a navigation button 1025 for navigating to the next interface, value interface 1100 (see FIG. 11), and a navigation button 1020 to navigate to the previous interface. Additionally, buttons, such as up/down arrows 1030 may be provided to enable the participant to scroll through and view all the text in each of fields 1005, 1010, and 1015.

Once the participants have modified, as necessary, the claim outline to exclude known prior art or prior art combinations, the participant selects navigation button 1025 to navigate to value interface 1100.

### Value Interface

The system includes an interface for evaluating the value of the invention. FIG. 11 shows an example of an interface 1100 for evaluating the value of the invention. It is preferable, though not required, for value interface 1100 to be accomplished after PAC interface 1000. Value interface 1100 displays the draft claim for consideration by the participants in an un-editable claim field 1105. Value criteria table 1110 includes criteria column 1112. The participants identify value criteria for evaluating the invention displayed in claim field 1105 and list these in criteria column 1112. The entry of value criteria can also be accomplished prior to interface 1100 by selecting preset value criteria button 535 in interface 500 (see FIG. 5). The criteria are preferably predetermined criteria that are part of the company's intellectual property strategy. Examples of criteria that might be used are shown in the table in Section 0.

The criteria are preferably displayed in a large scrollable table, e.g. value criteria table 1110. Alternatively, they may be displayed on a series of screens, preferably with the claim displayed on each screen, so that the questions can be considered in light of the claim. The criteria can be weighted, if desired, and the system can be programmed to produce a score for the invention. At least two participants vote, as described in Section 0, and the vote scores may be tallied as described in that section.

The criteria used in value interface 1100 are preferably established before the invention review session, as part of a strategy session. However, if no criteria have been established prior to the review board, establishing the criteria may be accomplished during the invention review session at any point during the invention review session.

Value interface 1100 preferably includes check boxes 1150 and 1155 for entry of a final value decision about the invention. To arrive at a final value decision, the participants individually evaluate the criteria questions in value criteria table 1110 to familiarize themselves with all of the issues, and with the issues in mind, the participants vote or by consensus assign a final decision about whether the invention will go forward. Alternatively, the final decision may be calculated automatically, based on scoring of the questions. Final decision radio buttons 1150 and 1155 are used to select whether the final decision made was to proceed or not proceed with further reviewing of the invention.

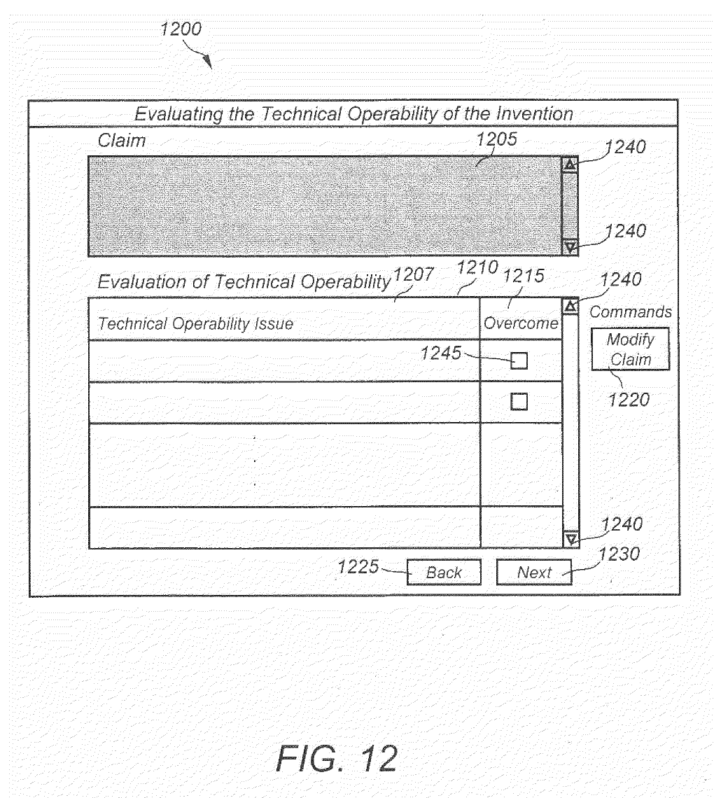

If the participant vote is to proceed with further reviewing of the invention, the participant selects final decision radio button 1150 and then selects navigation button 1130 to display the next interface, operability interface 1200 (see FIG. 12). However, if the participant vote is to not proceed with further reviewing of the invention, the participant selects final decision radio button 1155 and then selects navigation button 1130, which ends the process and returns the participant to the entering inventions interface 500. The participant may, if there are further inventions to be reviewed, enter or select another invention and begin the process again.

Value criteria table 1110 also includes participant columns 1115 that allows for the participants to enter their vote for each criterion. Votes may be in any suitable manner, e.g., numerical value, Y/N, etc. Participant columns can be added to or deleted from column 1115 using an edit participant button 1120 that allows for the desired edits to be made.

Additionally, buttons, such as scroll arrows 1135 may be provided to enable the participant to scroll through and view all the text in each of claim field 1105 and value criteria table 1110.

### Technical Operability Interface

The system includes an interface for voting on the technical operability of the invention. FIG. 12 shows an example of an interface 1200 for voting on the technical operability of the invention. Interface 1200 includes the present version of the claim in an un-editable claim field 1205 and a field 1210 for entry of technical operability issues. The participants identify technical operability issues and list these in the technical operability issues column 1207 in technical operability table 1210. Technical operability table 1210 also includes an operability issue overcome column 1215 for indicating whether the corresponding technical operability issue is overcome by the claim in its present form. Column 1215 may include check boxes, such as boxes 1245, as a means to indicate that the corresponding technical operability issue has been overcome.

Additionally, buttons, such as up/down arrows 1240 may be provided to enable the participant to scroll through and view all the text in each of claim field 1205 and technical operability table 1210. Interface 1200 also includes navigation buttons 1225 and 1230, which allow the participant to navigate back an interface or navigate to the next interface, respectively.

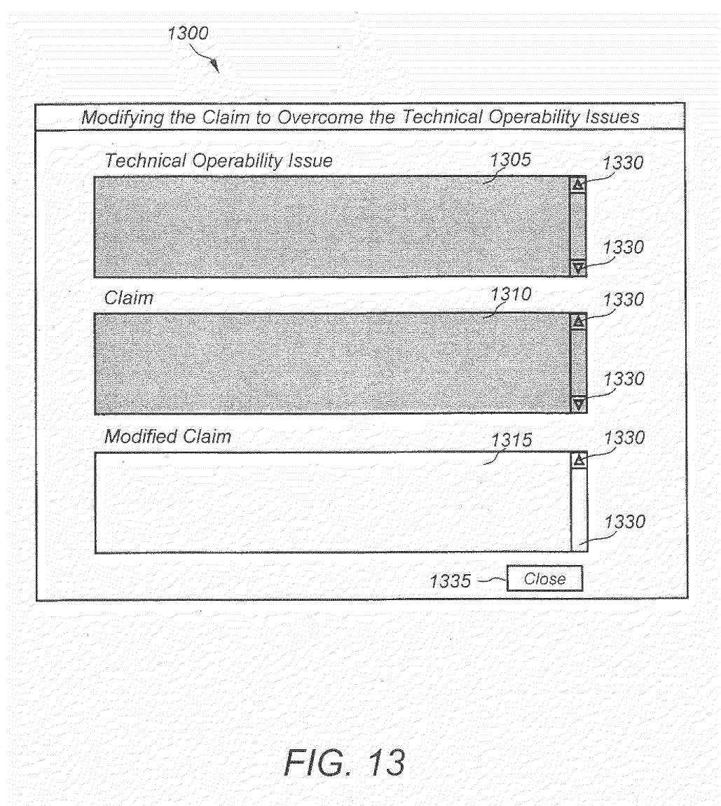

If a technical operability issue is not overcome by the invention with its claim in its present form, the user selects a modify claim button 1220 that displays an interface 1300 for modifying the claim to overcome the technical operability issue (see FIG. 13).

Interface 1300 displays the technical operability issue to be overcome in a non-editable field 1305, and the present form of the claim in non-editable field 1310. Interface 1300 further includes a modifiable field 1315, for entering a modified claim of the invention to overcome the technical operability issue. The participants collaborate to modify the invention and therefore the claim to overcome the technical operability issues, and then enter the modified claim into field 1315. Once the claim has been modified so that the invention overcomes the technical operability issue, the participant selects close button 1335, whereupon interface 1200 for voting on the technical operability of the invention is displayed again and a check is written to the box 1245 corresponding to the overcome technical operability issue.

Additionally, interface 1300 includes buttons, such as scroll arrows 1330 to enable the participant to scroll through and view all the text in each of the fields 1305, 1310, and 1315.

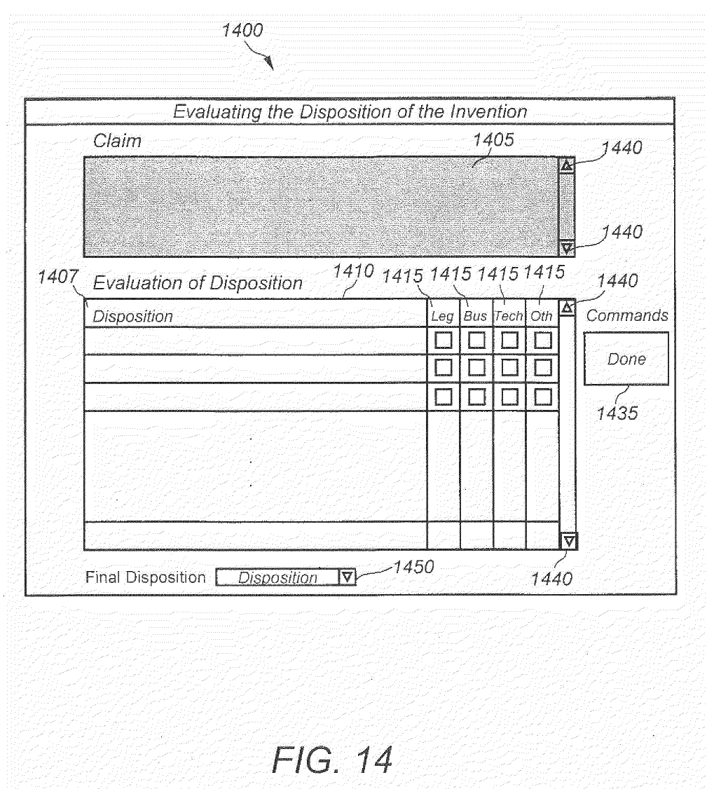

The above process is repeated for all listed technical operability issues in technical operability table 1210. Once all technical operability issues have been resolved, the participant selects navigation button 1230 to navigate to the next interface, disposition interface 1400 (see FIG. 14).

Because the modification of the claim to overcome technical operability issues may affect the judgments in the evaluation of the value of the invention in value interface 1100, it may be useful at this point in the process to reconsider the value questions in value interface 1100. To accomplish this, the participant would select navigation icon 1225 to return to value interface 1100 and repeat the process as described above in the section entitled “Value Interface.”

### Disposition Interface

The system includes an interface for voting on and/or inputting the invention disposition. FIG. 14 shows an example of an interface 1400 for evaluating and/or inputting invention disposition. The interface displays the final claim in a non-editable claim field 1405, and includes a set of pre-defined disposition criteria listed in disposition column 1407 a disposition evaluation table 1410. These criteria are designed to make the participants aware of the issues relating to whether the invention is a good candidate for trade secret protection, patent protection or defensive publication. Each criterion is associated with one or more columns 1415 representing each participant voting and permitting the participants to assess the criteria, e.g., by a yes/no answer or by a score for each criteria.

The disposition interface 1400 preferably includes a field for entry of a final disposition decision about the invention. To arrive at a final disposition decision, the participants answer the pre-defined disposition criteria questions in disposition evaluation table 1410 to familiarize each with all of the issues, and with the issues in mind, the participants vote or by consensus assign a final disposition decision for the invention. Alternatively, the final decision may be calculated automatically, based on scoring of the questions. Once the final disposition decision is made, the final disposition is entered into a final disposition combo box 1450. A list of dispositions may be pre-loaded into final disposition combo box 1450, thus allowing the participant to select the appropriate disposition from a list of pre-loaded dispositions. Alternatively, the participant may directly enter the disposition to final disposition combo box 1450. Examples of dispositions are described in Section 0.

Additionally, interface 1400 includes arrows 1440 that allow the participant to scroll through field claim 1405 and disposition evaluation table 1410.

Once the final disposition has been assigned, the participant returns to interface 500 by selecting done button 1435.

As described above, the interfaces illustrated in FIGS. 9-14 each contain a field in which the last-modified version of the claim is depicted. Making the most current version of the claim continuously available in this manner aids the process of reviewing and reaching a final disposition relative to the invention by avoiding the need to scroll back and forth between various interfaces to find such version of the claim.

### Report Interface

The system includes an interface for generating reports containing information about the activities of the review board in the invention review process discussed above. FIG. 15 shows an example of an interface 1500 for generating reports. The system may generate a detail listing report that includes some or all of the information about each invention in the database. Another example of a report that may be generated by the system of the invention is a disposition report, which includes information about each invention, including the title, final claim and disposition of each invention in the database. Yet another example of a report that may be generate is a claim history report that shows all the changes made to the claim during the invention review process.

In operation, the participant selects the desired report button, e.g., list of dispositions of all inventions report button 1505 and/or detailed listing of each invention report button 1510. Once selected the system generates the report. While the present invention has been described in connection with a preferred embodiment, it will be understood that it is not so limited. On the contrary, it is intended to cover all alternatives, modifications, and equivalents as may be included within the spirit and scope of the invention as defined above and in the claims appended hereto.

What is claimed is:

1. A system for reviewing an invention by at least one reviewer, the system comprising:
a computer database;
a problem interface configured to prompt the at least one reviewer to input into said problem interface one or more technical problem statements and one or more business problem statements directed to the invention and to store the technical and business problem statements in said computer database;
an element interface configured to prompt the at least one reviewer to input into said element interface elemental descriptions of the invention as a function of ones of the technical and business problem statements stored in said computer database and to store the elemental descriptions in said computer database; and
a claim generator configured to automatedly generate an initial patent claim for the invention using ones of the technical and business problem statements stored in said computer database and using ones of the elemental descriptions corresponding to the ones of the technical and business problem statements used by said claim generator to generate the initial patent claim.

2. The system according to claim 1, further comprising a claim editing interface configured to 1) display the initial patent claim contemporaneously with a first claim editing region, 2) prompt the at least one reviewer to draft in said first claim editing region a first revised patent claim and 3) store the first revised patent claim in said computer database.

3. The system according to claim 2, further comprising a reverse morphology matrix interface configured to 1) display one of the elemental descriptions of the invention stored in said computer database contemporaneously with an alternative term region, 2) prompt the at least one reviewer to input into said alternative term region at least one alternative term for the one of the elemental descriptions currently displayed by said reverse morphology matrix interface and 3) store in said computer database the at least one alternative term in relation with the one of the elemental descriptions currently displayed by said reverse morphology matrix interface.

4. The system according to claim 3, wherein said reverse morphology matrix interface is further configured to 1) automatedly generate a list of synonyms for the one of the elemental descriptions currently displayed by said reverse morphology interface matrix and 2) permit the at least one reviewer to individually select ones of the synonyms on the list for listing in said alternative term region and for storage in said computer database.

5. The system according to claim 3, further comprising a prior art comparison interface configured to 1) display the first revised patent claim contemporaneously with a second claim editing region and a prior art text region, 2) prompt the at least one reviewer to draft in said second claim editing region a second revised patent claim as a function of prior art described in said prior art text region and 3) store the second revised patent claim in said computer database.

6. The system according to claim 5, further comprising a value interface configured to 1) display one of a) the first revised patent claim and b) the second revised patent claim contemporaneously with a value evaluation region configured to display evaluation criteria, 2) prompt the at least one reviewer to enter in said value interface evaluation identifiers for business value, technical value and legal value and 3) store the evaluation identifiers in said computer database.

7. The system according to claim 6, further comprising a technical operability interface configured to 1) prompt the at least one reviewer to enter in said technical operability interface at least one technical operability issue statement and a status indicator for the at least one technical operability issue statement and 2) store in the computer database the at least one technical operability issue statement and the status indicator.

8. The system according to claim 7, wherein said technical operability interface is further configured to 1) display one of a) the first revised patent claim and b) the second revised patent claim contemporaneously with the at least one technical operability issue statement stored in said computer database and further contemporaneously with a third claim editing region, 2) prompt the at least one reviewer to draft in said third claim editing region a third revised patent claim as a function of the at least one technical operability issue statement displayed by said technical operability interface and 3) store the third revised patent claim in said computer database.

9. The system according to claim 8, further comprising a disposition interface configured to 1) display one of a) the first revised patent claim, b) the second revised patent claim and c) the third revised patent claim contemporaneously with a list of disposition questions, 2) prompt the at least one reviewer to provide responses to the disposition questions and 3) store the responses in said computer database.

10. The system according to claim 9, wherein said disposition interface is configured to automatedly determine a disposition of the invention based on the responses stored in said computer database.

11. The system according to claim 9, wherein ones of said problem interface, said element interface, said claim editing interface, said morphology matrix interface, said prior art comparison interface, said value interface, said technical operability interface and said disposition interface are integrated into a combined interface.

12. A system for reviewing an invention by at least one reviewer using a machine, the system comprising:
first means for storing digital data;
second means for prompting the at least one reviewer to input into the machine one or more technical problem statements and one or more business problem statements directed to the invention and for storing the technical and business problem statements in said first means;
third means for prompting the at least one reviewer to input into the machine elemental descriptions of the invention as a function of ones of the technical and business problem statements stored in said first means and for storing the elemental descriptions in said first means; and
fourth means for automatedly generating an initial patent claim for the invention using ones of the technical and business problem statements stored in said first means and using ones of the elemental descriptions corresponding to the ones of the technical and business problem statements used by said fourth means to generate the initial patent claim.

13. The system according to claim 12, further comprising fifth means for 1) displaying the initial patent claim contemporaneously with a first claim editing region, 2) prompting the at least one reviewer to draft in said first claim editing region a first revised patent claim and 3) storing the first revised patent claim in said storage means.

14. The system according to claim 13, further comprising sixth means for 1) displaying one of the elemental descriptions of the invention stored in said first means contemporaneously with an alternative term region, 2) prompting the at least one reviewer to input into said alternative term region at least one alternative term for the one of the elemental descriptions currently displayed by said sixth means and 3) storing in said first means the at least one alternative term in relation with the one of the elemental descriptions currently displayed by said sixth means.

15. The system according to claim 14, wherein said sixth means further comprises means for 1) automatedly generating a list of synonyms for the one of the elemental descriptions currently displayed by said sixth means and 2) permitting the at least one reviewer to individually select ones of the synonyms on the list for listing in said alternative term region and for storage in said first means.

16. The system according to claim 14, further comprising seventh means for 1) displaying the first revised patent claim contemporaneously with a second claim editing region and a prior art text region, 2) prompting the at least one reviewer to draft in said second claim editing region a second revised patent claim as a function of prior art described in said prior art text region and 3) storing the second revised patent claim in said first means.

17. The system according to claim 16, further comprising eighth means for 1) displaying one of a) the first revised patent claim and b) the second revised patent claim contemporaneously with a value evaluation region configured to display evaluation criteria, 2) prompting the at least one reviewer to enter into the machine evaluation identifiers for business value, technical value and legal value and 3) storing the evaluation identifiers in said first means.

18. The system according to claim 17, further comprising ninth means for 1) prompting the at least one reviewer to enter into the machine at least one technical operability issue statement and a status indicator for the at least one technical operability issue statement and 2) storing in the first means the at least one technical operability issue statement and the status indicator.

19. The system according to claim 18, wherein said ninth means further includes means for 1) displaying one of a) the first revised patent claim and b) the second revised patent claim contemporaneously with the at least one technical operability issue statement stored in said first means and further contemporaneously with a third claim editing region, 2) prompting the at least one reviewer to draft in said third claim editing region a third revised patent claim as a function of the at least one technical operability issue statement displayed by said ninth means and 3) storing the third revised patent claim in said first means.

20. The system according to claim 19, further comprising tenth means for 1) displaying one of a) the first revised patent claim, b) the second revised patent claim and c) the third revised patent claim contemporaneously with a list of disposition questions, 2) prompting the at least one reviewer to provide responses to the disposition questions and 3) storing the responses in said first means.

21. The system according to claim 20, wherein said tenth means further includes means for automatedly determining a disposition of the invention based on the responses stored in said first means.

22. Machine-readable media containing machine-executable instructions for performing a method of reviewing an invention by at least one reviewer, the machine executable instructions comprising:
a first set of machine-executable instructions for prompting the at least one reviewer to input into a machine one or more technical problem statements and one or more business problem statements directed to the invention and for storing the technical and business problem statements on the machine;
a second set of machine-executable instructions for prompting the at least one reviewer to input into the machine elemental descriptions of the invention as a function of ones of the technical and business problem statements stored in said first means and for storing on the machine the elemental descriptions; and
a third set of machine-executable instructions for automatedly generating an initial patent claim for the invention using ones of the technical and business problem statements stored on the machine and using ones of the elemental descriptions corresponding to the ones of the technical and business problem statements used by said third set of machine-executable instructions to generate the initial patent claim.

23. The machine-readable media according to claim 22, further comprising a fourth set of machine-executable instructions for 1) displaying the initial patent claim contemporaneously with a first claim editing region, 2) prompting the at least one reviewer to draft in said first claim editing region a first revised patent claim and 3) storing the first revised patent claim on the machine.

24. The machine-readable media according to claim 23, further comprising a fifth set of machine-executable instructions for 1) displaying one of the elemental descriptions of the invention stored on the machine contemporaneously with an alternative term region, 2) prompting the at least one reviewer to input into said alternative term region at least one alternative term for the one of the elemental descriptions currently displayed by said fifth set of machine-executable instructions and 3) storing on the machine the at least one alternative term in relation with the one of the elemental descriptions currently displayed by said fifth set of machine-executable instructions.

25. The machine-readable media according to claim 24, wherein said fifth set of machine-executable instructions further comprises machine-executable instructions for 1) automatedly generating a list of synonyms for the one of the elemental descriptions currently displayed by said fifth set of machine-executable instructions and 2) permitting the at least one reviewer to individually select ones of the synonyms on the list for listing in said alternative term region and for storage on the machine.

26. The machine-readable media according to claim 24, further comprising a sixth set of machine-executable instructions for 1) displaying the first revised patent claim contemporaneously with a second claim editing region and a prior art text region, 2) prompting the at least one reviewer to draft in said second claim editing region a second revised patent claim as a function of prior art described in said prior art text region and 3) storing the second revised patent claim on the machine.

27. The machine-readable media according to claim 26, further comprising a seventh set of machine-executable instructions for 1) displaying one of a) the first revised patent claim and b) the second revised patent claim contemporaneously with a value evaluation region configured to display evaluation criteria, 2) prompting the at least one reviewer to enter into the machine evaluation identifiers for business value, technical value and legal value and 3) storing the evaluation identifiers on the machine.

28. The machine-readable media according to claim 27, further comprising an eighth set of machine-executable instructions for 1) prompting the at least one reviewer to enter into the machine at least one technical operability issue statement and a status indicator for the at least one technical operability issue statement and 2) storing on the machine the at least one technical operability issue statement and the status indicator.

29. The machine-readable media according to claim 28, wherein said eighth set of machine-executable instructions further includes machine-executable instructions for 1) displaying one of a) the first revised patent claim and b) the second revised patent claim contemporaneously with the at least one technical operability issue statement stored on the machine and further contemporaneously with a third claim editing region, 2) prompting the at least one reviewer to draft in said third claim editing region a third revised patent claim as a function of the at least one technical operability issue statement displayed by said eighth set of machine-executable instructions and 3) storing the third revised patent claim on the machine.

30. The machine-readable media according to claim 29, further comprising a ninth set of machine-executable instructions for 1) displaying one of a) the first revised patent claim, b) the second revised patent claim and c) the third revised patent claim contemporaneously with a list of disposition questions, 2) prompting the at least one reviewer to provide responses to the disposition questions and 3) storing the responses on the machine.

31. The machine-readable media according to claim 30, wherein said ninth set of machine-executable instructions further includes machine-executable instructions for automatedly determining a disposition of the invention based on the responses stored on the machine.

32. A method of reviewing an invention by at least one reviewer, comprising:
prompting the at least one reviewer to input into an invention-review machine one or more technical problem statements and one or more business problem statements directed to the invention;
prompting the at least one reviewer to input into the invention-review machine elemental descriptions of the invention as a function of ones of the technical and business problem statements stored on the invention-review machine; and
automatedly generating an initial patent claim for the invention using ones of the technical and business problem statements input into the invention-review machine and using ones of the elemental descriptions corresponding to the ones of the technical and business problem statements.

33. The method according to claim 32, further comprising:
displaying the initial patent claim;
prompting the at least one reviewer to input into the invention-review machine a first revised patent claim while viewing said displaying of the initial patent claim; and
recording the first revised patent claim.

34. The method according to claim 33, further comprising:
displaying one of the elemental descriptions of the invention input into the invention-review machine;
prompting the at least one reviewer to input into the invention-review machine at least one alternative term for the one of the elemental descriptions currently displayed; and
recording the at least one alternative term in relation with the one of the elemental descriptions currently displayed.

35. The method according to claim 34, further comprising:
automatedly generating a list of synonyms for the one of the elemental descriptions currently displayed by said fifth set of machine-executable instructions; and
permitting the at least one reviewer to individually select ones of the synonyms on the list for listing in the alternative term.

36. The method according to claim 34, further comprising:
displaying the first revised patent claim;
prompting the at least one reviewer to draft a second revised patent claim while viewing said displaying of the first revised patent claim and while viewing a description of prior art; and
recording the second revised patent claim.

37. The method according to claim 36, further comprising:
displaying one of a) the first revised patent claim and b) the second revised patent claim;
prompting the at least one reviewer to assign evaluation identifiers to evaluation criteria while viewing said displaying of the one of a) the first revised patent claim and b) the second revised patent claim, wherein the evaluation identifiers indicate business value, technical value and legal value; and
recording the evaluation identifiers.

38. The method according to claim 37, further comprising prompting the at least one reviewer to record at least one technical operability issue statement and a status indicator corresponding to the at least one technical operability issue statement.

39. The method according to claim 38, further comprising:
displaying one of a) the first revised patent claim and b) the second revised patent claim contemporaneously with the at least one technical operability issue statement stored on the invention-review machine;
prompting the at least one reviewer to draft a third revised patent claim as a function of the at least one technical operability issue statement displayed; and
recording the third revised patent claim.

40. The method according to claim 39, further comprising:
displaying one of a) the first revised patent claim, b) the second revised patent claim and c) the third revised patent claim contemporaneously with a list of disposition questions;
prompting the at least one reviewer to provide responses to the disposition questions; and recording the responses.

41. The method according to claim 40, further comprising automatedly determining a disposition of the invention based on the responses recorded in said recording of the responses.
